(19) United States
(12) Patent Application Publication
(10) Pub. No.: US 2003/0110036 A1
(43) Pub. Date: Jun. 12, 2003

(54) Chinese input method for providing auxiliary writing model

(76) Inventors: Sayling Wen, Taipei (TW); Zechary Chang, Taipei (TW); Leger Wu, Beijinh (CN); Back Zhang, Beijinh (CN)

Correspondence Address: BIRCH STEWART KOLASCH & BIRCH, PO BOX 747, FALLS CHURCH, VA, 22040-0747, US

(21) Appl. No.: 10/006,351

(22) Filed: Dec. 10, 2001

(51) Int. Cl. G10L 15/28

(52) U.S. Cl. 704/255

(57) ABSTRACT

A Chinese input method for providing an auxiliary writing model accelerates data processing for users. Also, it provides the users with expanded functions to customize models. The method comprises: (1) activating word processing software and opening a file editing block; (2) activating an input method interface through the file editing block; (3) selecting a writing model active button to execute a writing model menu module; and (4) the writing model content database returning the corresponding writing model content to the file editing block.

### BACKGROUND OF THE INVENTION

1. Field of the Invention

The invention relates to a Chinese input method executable on system platforms in computers, and more particularly to a Chinese input method for providing auxiliary writing models in word processing software.

2. Related Art

There have recently been a number of inventions relating to processes of Chinese character input. The Chinese character input methods of the prior art are of two main types: (1) designing word input methods (for example, the Cang-Xie input method, the Wu-Xia-Mi input method, the Da-Yi input method, and the line-row input method, etc.), and (2) designing candidate words selection. However, these methods only involve a single word, single phrase, or maybe single sentence input. When users must process a large amount of data of similar structures, these input methods are not efficient enough for users.

To solve the above mentioned problem, some word processing software (such as Word) has provided various software models. However, this kind of word processing software has its own file format, so the models provided in this kind of software cannot be used with other word processing software. Therefore, the advantage of the models provided in this kind of software is reduced. Furthermore, most word processing software that provides auxiliary models packs the model contents in the software programs fixedly. They do not provide functions for users to expand. Therefore, when the original models are not enough for the users, the users must use traditional input methods to input one character or phrase at a time. This is ineffective. Because it cannot overcome the limitation of software platforms, the model documents cannot be used in different word processing software.

### SUMMARY OF THE INVENTION

A primary objective of the invention is therefore to provide a Chinese input method for providing auxiliary writing models to solve the above mentioned problems.

According to claimed invention, the Chinese input method for providing an auxiliary writing model to accelerate Chinese inputting comprises the following steps: (1) activating word processing software to open a file editing block; (2) activating an input method interface through the file editing block; (3) selecting a writing model active button to execute a writing model menu module; and (4) the writing model content database returning the corresponding writing model content to the file editing block.

An advantage of the invention is that the Chinese input method provides defined models with themes to solve the problem of repeatedly inputting individual Chinese characters.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1-a is an entire flow chart of the Chinese input method for providing an auxiliary writing model of the invention.

FIG. 1-b is an entire flow chart of the Chinese input method for providing an auxiliary writing model of the invention.

FIG. 1-c is an entire flow chart of the Chinese input method for providing an auxiliary writing model of the invention.

FIG. 2 is a diagram of a preferred embodiment of the Chinese input method for providing an auxiliary writing model of the invention.

### DETAILED DESCRIPTION OF THE INVENTION

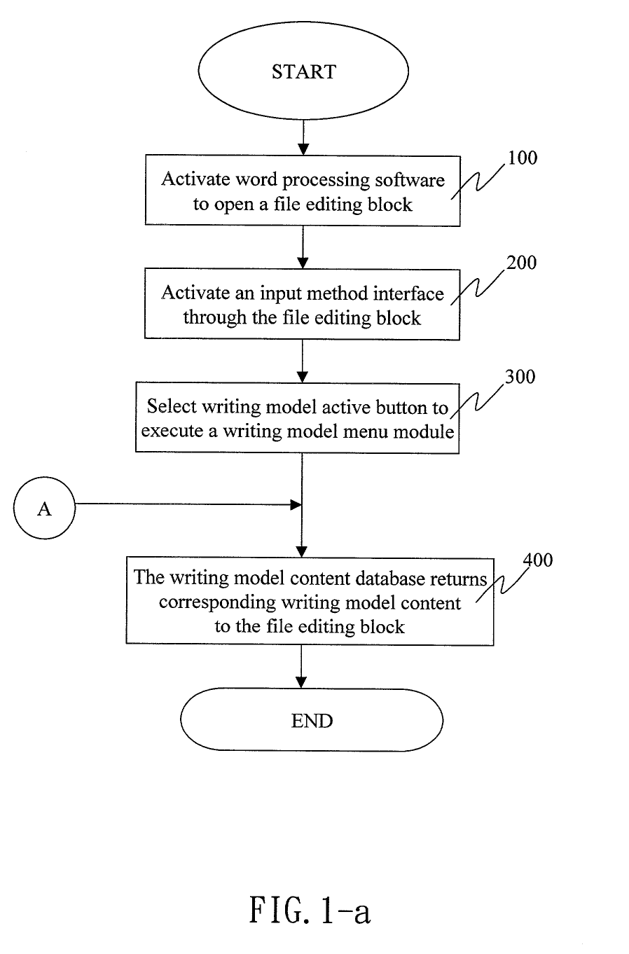

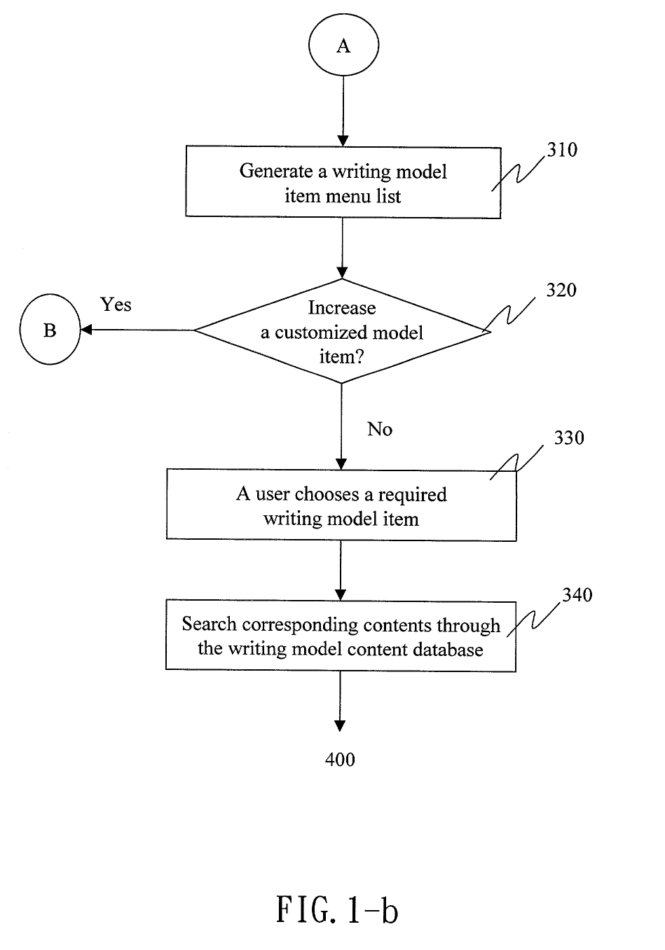

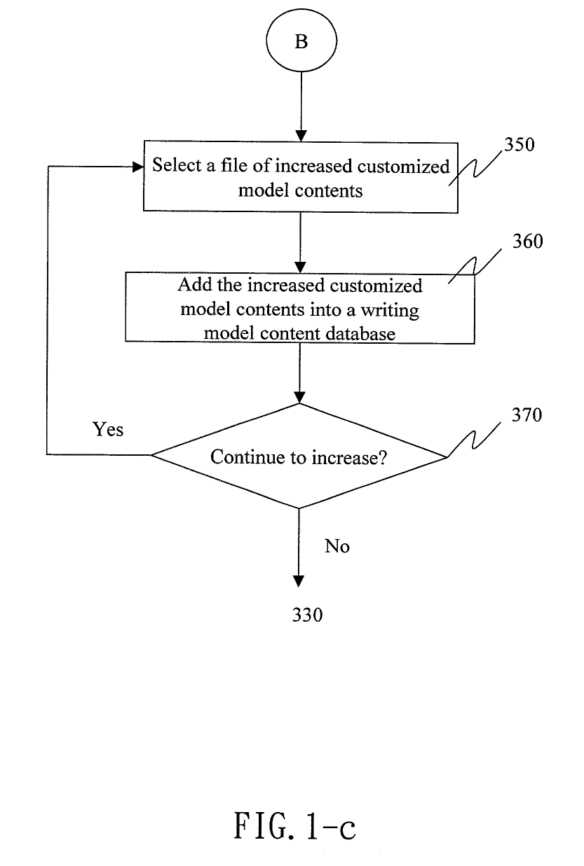

The invention provides a Chinese input method for providing an auxiliary writing model. First, please refer to FIG. 1-a., which is an entire flow chart of the Chinese input method for providing an auxiliary writing model of the invention.

First, a user 500 must activate word processing software 600 on a computer system platform and open a file editing block (step 100) so that the file can be used to execute inputting and editing. Then the user activates an input method interface 700 through the file editing block (step 200). Using a predetermined hot key, the user 500 selects a writing model active button to execute and call a writing model menu module 710 in the input method interface (step 300). The writing model active button is on the input method interface 700 to allow the user 500 to call the writing models any time in a state of input method activating. Next, the writing model menu module goes to step A. Finally, corresponding writing model content 813 searched by the writing model content database 800 is returned to the file editing block of the word processing software 600 (step 400) for the user 500 to input, edit, and modify the model contents to finish the process.

Next, please refer to FIG. 1-b, which is an entire flow chart of the Chinese input method for providing an auxiliary writing model of the invention. This figure describes the processes of the writing model menu module.

After step A, the writing model menu module 710 generates a writing model item menu list 711 first by way of a popup window (step 310). Next, a dialog box appears to ask the user whether to increase a customized model item (step 320). If the user wants to add the pre-designed new model content into the writing model content database 800, then the flow goes to step B. However, if the user does not want to increase the customized model item but wants to use existing models, then the writing model item menu list 711 (step 310) is used to select required items. The writing model item menu list 711 comprises a plurality of writing model items 712 and a confirmation button 713. The user can select any writing model item through basic input devices. When the user selects one of the writing model items (step 330) and presses the confirmation button 713, a writing model item selection signal is generated. Next, the signal is transferred to the writing model content database 800. Through the writing model content database 800, corresponding model contents are searched (step 340). The flow then goes back to FIG. 1-a, and the corresponding writing model content 813 searched by the writing model content database 800 is returned to the file editing block of the word processing software 600 (step 400).

If the user chooses to increase a new model item, the flow of the method goes to step B, i.e. the entire flow chart of the Chinese input method for providing an auxiliary writing model in FIG. 1-c. The user must select a file of self-defined model content to be increased (step 350). The file is a text file that is pre-created by the user and stored in a system storage medium. When the file is selected, the user can add the increased self-defined model content into the writing model content database by clicking the confirmation button 713 provided by the writing model item menu list 711 (step 360). It then becomes a new model for the user to select quickly in the future. Next, the writing model item menu list 711 asks whether to continue to increase other model items (step 370). If the user selects yes, the flow goes back to select a file of self-defined model content to be increased (step 350). If the user selects no, then the system goes back to step 330, and lets the user selects required writing model items.

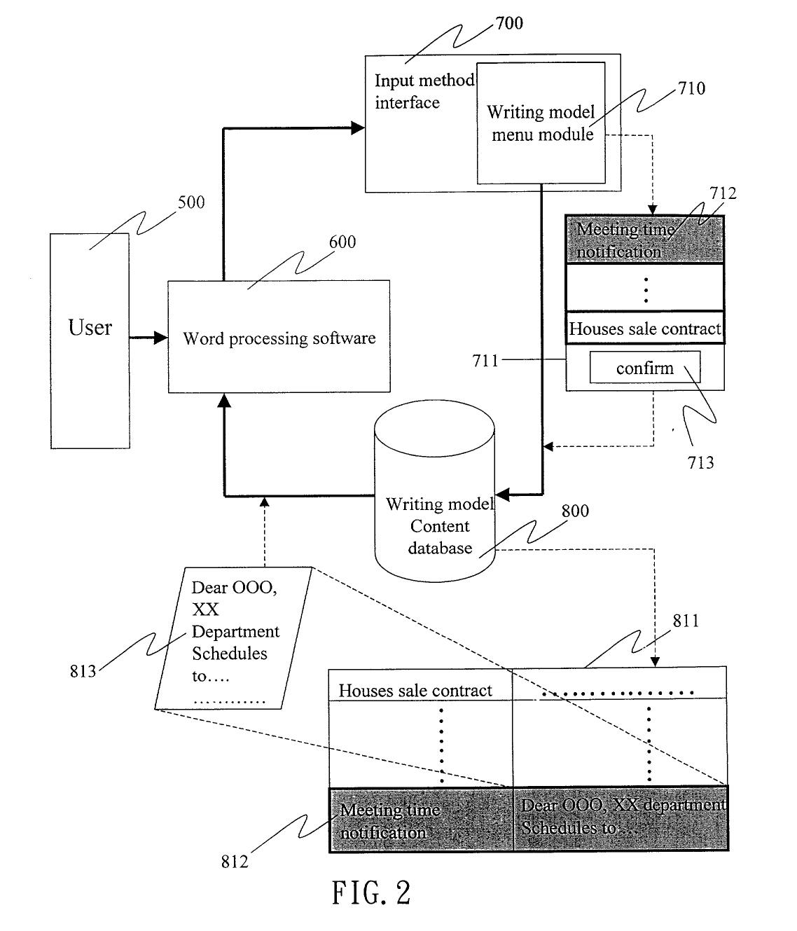

For describing how the user uses the present invention, a preferred embodiment is provided to explain the invention in more detail. Please refer to FIG. 2, which is a diagram of a preferred embodiment of the Chinese input method for providing an auxiliary writing model of the invention.

First, the user 500 activates word processing software 600 (such as NotePad, WordPad, UltraEdit, Han-Shu, etc.) on the computer system platform. In the preferred embodiment, NotePad is taken as the software used by the user 500. Activate a file editing block so that the file can be edited. Next, activate the input method interface 700 of the invention. At this time, the user 500 can click writing model active buttons provided by the input method interface anytime to execute and call the function of the writing model menu module 710. Now, the user 500 can see the writing model item menu list 711 in a popup window of the writing model menu module 710. The menu is basically divided into two parts: one is a plurality of writing model items 712 (including a meeting time notification, a houses sale contract, etc.), the other is a confirmation button 713 for the users to confirm after selecting items.

When the user 500 selects the writing model “meeting time notification”, for example, and confirms the selected item, s/he can click the confirmation button 713 provided by the writing model item menu list 711 to confirm. Meanwhile, a signal indicating the selection of the “meeting time notification” writing model item is sent to the writing model content database 800. At this time, the writing model corresponding data sheet 811 of the database receives the selection signal from the writing model item menu list 711 and automatically searches corresponding writing model item names 812 and corresponding writing model content 813 (for example, “Dear OOO, XX Department Schedules to . . . . ”). After finding the corresponding data content in the database, the writing model content database 800 sends back the searched corresponding writing model content “Dear 000, XX Department Schedules to . . . . ” 813 to the NotePad word processing software 600 used by the user 500, and writes the content read from the database into the active file editing block for the user to further modify and edit.

The above mentioned word processing software 600 and the hardware platform executable on the computer used by the Chinese input method of the invention can be a personal computer (PC), a notebook (NB), or a personal digital assistant (PDA).

Furthermore, the hot key functions used in the invention can be the key combinations which comprise the number keys 0˜9, letter keys A˜Z, function keys F1˜F12, and special keys ESC, TAB, PgUp, END.

The selecting devices and input devices used in the operating processes of the invention can be a keyboard, a mouse, a digital touch panel, or a voice identification system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Chinese input method for providing an auxiliary writing model to speed up Chinese inputting; the method comprising:
activating a word processing software to open a file editing block;
activating an input method interface through the file editing block;
selecting a writing model active button to execute a writing model menu module; and
the writing model content database returning the corresponding writing model content to the file editing block.

2. The Chinese input method for providing an auxiliary writing model of claim 1 wherein the word processing software is a word processing application software executable on a hardware platform of a computer.

3. The Chinese input method for providing an auxiliary writing model of claim 2 wherein the hardware platform of the computer can be a personal computer (PC), a note book (NB), or a personal digital assistant (PDA).

4. The Chinese input method for providing an auxiliary writing model of claim 1 wherein the operation of activating the input method interface is performed through a predetermined hot key.

5. The Chinese input method for providing an auxiliary writing model of claim 2 wherein the key combination of the hot key comprises number keys 0˜9, letter keys A˜Z, function keys F1˜12, and special keys ESC, TAB, PgUp, END.

6. The Chinese input method for providing an auxiliary writing model of claim 1 wherein the method of executing the writing model menu module comprises:
generating a writing model item menu list;
determining whether to increase a customized model item or not;
a user choosing a required writing model item; and
searching corresponding contents through the writing model content database.

7. The Chinese input method for providing an auxiliary writing model of claim 6 wherein the customized model item comprises:
selecting a file of increased customized model contents; and
adding the increased customized model contents into a writing model content database.

8. The Chinese input method for providing an auxiliary writing model of claim 7 wherein the file of increased customized model contents is a text-only file.

9. The Chinese input method for providing an auxiliary writing model of claim 6 wherein the writing model item menu list is presented with a popup window way by selecting a writing model active button.

10. The Chinese input method for providing an auxiliary writing model of claim 6 wherein the writing model active button is on the input method interface.

11. The Chinese input method for providing an auxiliary writing model of claim 6 wherein the writing model item menu list comprises a plurality of writing model items and a confirmation button.

12. The Chinese input method for providing an auxiliary writing model of claim 6 wherein the required writing model item generates a signal of selecting writing model items through an operation of selecting the confirmation button.

13. The Chinese input method for providing an auxiliary writing model of claim 12 wherein the operation of selecting the confirmation button is performed through a basic input device.

14. The Chinese input method for providing an auxiliary writing model of claim 13 wherein the basic input device can be a keyboard, a mouse, a digital touch panel, or a voice identification system.

15. The Chinese input method for providing an auxiliary writing model of claim 6 wherein the writing model content database comprises a writing model corresponding table.

16. The Chinese input method for providing an auxiliary writing model of claim 6 wherein the writing model corresponding table comprises a plurality of twin corresponding writing model item names and corresponding writing model contents.
